(19) United States
(12) Patent Application Publication
(10) Pub. No.: US 2012/0307668 A1
(43) Pub. Date: Dec. 6, 2012

(54) Methods and Devices Which Enable Considering a Number of Active User Stations Linked Via Relays When Allocating Radio Resources

(75) Inventors: Henning Wiemann, Aachen (DE); Magnus Stattin, Sollentuna (SE); Gunnar Mildh, Sollentuna (SE)

(73) Assignee: TELEFONAKTIEBOLAGET L M ERICSSON (PUBL), Stockholm (SE)

(21) Appl. No.: 13/577,494

(22) PCT Filed: Jun. 28, 2010
(86) PCT No.: PCT/SE10/50739

§ 371 Date: Aug. 7, 2012

Related U.S. Application Data
(60) Provisional application No. 61/305,053, filed on Feb. 16, 2010.

(51) Int. Cl. H04W 72/08; H04W 24/10; H04B 7/14

(52) U.S. Cl. 370/252; 370/315

(57) ABSTRACT

In a radio communication system, a relay node that relays data received from an anchor node to user stations, determines and transmits information about a number of active user stations linked to the relay node, to the anchor node. The anchor node allocates radio resources according to the received information about the number of active user stations.

### TECHNICAL FIELD

The present invention generally relates to radio communication systems, user terminals, software and methods and, more particularly, to mechanisms and techniques for handling communications in radio communication systems which include relays.

### BACKGROUND

At its inception radio telephony was designed, and used for, voice communications. As the consumer electronics industry continued to mature, and the capabilities of processors increased, more devices became available to use wireless transfer of data and more applications became available that operate based on such transferred data. Of particular note are the Internet and local area networks (LANs). These two innovations allowed multiple users and multiple devices to communicate and exchange data between different devices of various device types. With the advent of these devices and capabilities, users (both business and residential) found the need to transmit data, as well as voice, from mobile locations.

The infrastructure and networks which support this voice and data transfer have likewise evolved. Limited data applications, such as text messaging, were introduced into the so-called “2G” systems, such as the Global System for Mobile (GSM) communications. Packet data over radio communication systems became more usable in GSM with the addition of the General Packet Radio Services (GPRS). 3G systems and, then, even higher bandwidth radio communications introduced by Universal Terrestrial Radio Access (UTRA) standards made applications like surfing the web more easily accessible to millions of users.

Even as new network designs are rolled out by network manufacturers, future systems which provide greater data throughputs to end user devices are under discussion and development. For example, the so-called 3GPP Long Term Evolution (LTE) standardization project is intended to provide a technical basis for radio communications in the decades to come. Among other things of note with regard to LTE systems is that they will provide for downlink communications (i.e., the transmission direction from the network to the mobile terminal) using orthogonal frequency division multiplexing (OFDM) as a transmission format, and will provide for uplink communications (i.e., the transmission direction from the mobile terminal to the network) using single carrier frequency division multiple access (FDMA). According to the LTE terminology, a radio bearer is a configured and assigned radio resource. Any communication in an LTE system is associated with assigned bearers. Any actual equipment may have multiple radio bearers assigned simultaneously. A bearer may have a Guaranteed Bit Rate (GBR) or be a non-GBR bearer (“best-effort” type).

Cellular networks such as LTE systems are foreseen to cover diverse geographic regions. On one hand, the cellular networks are anticipated to cover urban areas with a high density of buildings with indoor users. On the other hand, cellular networks shall also provide access over large geographic regions in remote rural areas. In both scenarios, it is challenging to cover the entire service area. Either huge parts are heavily shadowed from the Base Station (BS) or the link distances are very large so that radio propagation characteristics may be altered by damping and non-uniform propagation conditions.

In order to cope with diverse radio propagation conditions, multi-hop communication has been proposed. By means of intermediate nodes, e.g., relays, the radio link is divided into two or more hops, each with better propagation conditions than the direct link. This enhances link quality which leads to an increased cell edge throughput and coverage enhancements.

Layer 2 (L2) relays operate in the data link layer and have the ability to detect, and possibly correct, errors that have occurred in the physical layer. L2 relays are therefore commonly called Decode-and-Forward (DF) relays as they decode the received data prior to retransmission. DF relays will, at the expense of an increased delay, not forward noise and interference. Layer 3 (L3) relays operate in the network layer and are regarded as being equivalent to eNodeBs (that is, E-UTRAN NodeBs, where E-UTRAN stands for Evolved UMTS Terrestrial Radio Access Network, and UMTS means Universal Mobile Telecommunication System) that are wirelessly connected to a donor cell via self-backhauling, i.e. wireless back-hauling of eNodeBs using LTE radio access technology. L3 relays have the same characteristics as L2 relays in the sense that they do not forward noise and interference thanks to a de-coding and error correction of the received signal prior to a retransmission.

FIG. 1 illustrates the relation of UE bearers and backhaul bearers. Generically, as illustrated in the line 4 of FIG. 1, a user equipment (UE) 5 receives communications from a core network through a Serving Gateway (S-GW) 6 and a self-backhauled eNodeB 7.

The self-backhauled eNodeB may be seen from a network perspective in at least three different ways. The three different ways correspond to three main architecture alternatives used to implement self-backhauling in LTE. The alternatives differ in terms of implications and the required changes on the E-UTRAN versus the EPC (Enhanced Packet Core) part of the system and in the extent of required changes as compared to the current standard. Each of these three alternatives is briefly described below.

In a first alternative, referred to herein as the “encapsulation approach”, the self-backhauled eNodeB is treated as if it were a UE (user equipment) with its own bearers and association with the EPC. As a consequence, the bearers of actual UEs served by the self-backhauled eNodeB (sNB) need to be multiplexed and carried within the bearers of the sNB (acting like a virtual UE). That is, the encapsulation of a UE bearer in another UE bearer needs to be performed, as shown in line 10 of FIG. 1.

In a second alternative, referred to herein as the “TN routing approach”, the self-backhauled eNodeB is seen as being part of the transport network (TN), acting like a transport network (TN) router. That is, the LTE self-backhaul link appears, in principle just as any other TN link. This alternative can be seen as a special case of the first alternative, see line 12 of FIG. 1.

In a third alternative, referred to herein as the “proxy approach”, the anchor eNodeB completely hides the self-backhauled eNodeB from the rest of the network. That is, a UE served by the self-backhauled eNodeB is seen from the upper part of the network as if the UE were connected to the anchor eNodeB directly, i.e., the proxy operation is transparent for the EPC. The sNB can be seen as it would be just a different cell of the anchor eNodeB (aNB). It is the responsibility of the aNB to mimic toward the EPC as if it were serving the UE and translate the signaling and forward user data to/from the self-backhauled eNodeB, see line 14 of FIG. 1. In this alternative, the aNB would be aware of the QoS configuration of the UEs connected to the sNB (since it translates the signaling).

In the encapsulation approach 10, the sNB has its bearers terminated in the EPC, i.e., the sNB has its own S-GW as regular UEs, which may be different from the S-GW serving the UE. The UE bearer is encapsulated into the sNB bearer in the S-GW serving the sNB. The TN routing approach 12 is a special case of the encapsulation approach where the S-GW function for the sNB is moved to the aNB. In both cases the UE bearer is transported transparently via the aNB, hidden in the sNB bearer. In the proxy approach 14 the aNB captures the UE bearer on S1, translates it to an internal “S1” bearer and multiplexes it into the backhaul radio bearer.

In at least the first of the architecture alternatives described above, the anchor eNodeB is not aware of the number of UEs being served by a connected relay node. This is due to the fact that the UEs' S1 bearers terminate in the relay node and the (S-GW (UE)). They are tunneled through the aNB which cannot, and does not need to, monitor the content of the tunnels. This approach allows for a particularly simple implementation of the aNB which treats relays like any other UE.

A problem with this approach is related to scheduling, QoS (Quality of Service) and fairness. Regular eNodeBs (without relaying) are expected to support fair scheduling among served UEs, i.e., they shall associate or allocate radio resources among UEs so that they achieve similar throughput. Actual scheduling strategies may, for example, be resource fair (same amount of resources per UE), throughput fair (same throughput) or “proportional” fair (taking into account throughput and e.g. channel quality).

In a relaying environment such as the one depicted in FIG. 1, data packets traverse at least two radio links, i.e., the one between the aNB (anchor) and the sNB (relay) (Un interface) as well as the one between sNB (relay) and UE (Uu interface). Furthermore, UEs may also be connected directly to the anchor eNodeB (Uu interface). Schedulers reside in the relay node and in the anchor eNodeB and they control the resource allocation for the Uu and Un interface, respectively. While the relay node's scheduler has full knowledge about all UEs and their radio bearers, the scheduler in the anchor eNodeB is only aware of the connected relay nodes as well as about UEs served by itself.

Due to this limitation, the eNodeB cannot achieve fairness among all UEs connected directly and via relays. The eNodeB can ensure that relays and the UEs connected directly to the eNodeB obtain a fair (similar) data rates. However, if the data flows of several UEs share a Un interface, these UEs will not be allocated resources to achieve a fair throughput.

In the third (proxy approach) architecture described above, the eNodeB terminates the S1 bearer for all UEs' radio bearers including those of served by relays. With this approach, the eNodeB can achieve fairness among all UEs and their radio bearers. However, this capability comes at the cost of excessive state handling, and requires significant changes to products and specifications.

Accordingly, it would be desirable to provide methods, devices, systems and software that would overcome the difficulty associated with allocating radio resources without taking into consideration both the UEs connected directly to the network and the UEs which are connected to the network via relay node(s), while avoiding the afore-described problems and drawbacks.

### SUMMARY

According to an embodiment, a method for informing an anchor node about a number of active user stations linked to a relay node, which relays data received from the anchor node to the user stations is provided. The method may include determining, by the relay node, a number of active user stations connected to the relay node, and transmitting a report including information about the number of active user stations, to the anchor node.

According to another embodiment, a relay node includes an interface, and a processing unit. The interface may be configured to communicate with an anchor node, and user stations, the relay node being configured to relay data transmitted between the anchor node and any of the user stations. The processing unit may be configured to determine a number of active user stations, and to control the interface to submit a report including information about the number of active user stations to the anchor node.

According to another embodiment, an anchor node capable to send data to user stations via a relay node includes an interface, and a scheduler. The interface may be configured to communicate with user stations via a relay node, and to receive a report including information about a number of active stations linked to the relay node. The scheduler may be configured to allocate available radio resources according to the received information about the number of active user stations.

According to another embodiment, method of allocating radio resources in an anchor node communicating with user stations via a relay node is provided. The method may include receiving from the relay node a report including information about a number of active user stations linked to the relay node, and allocating radio resources according to the received information about the number of active user stations.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic representation which illustrates alternatives used to implement self-backhauling in LTE.

FIG. 2 illustrates an exemplary radio communication system.

FIGS. 3(a) and 3(b) illustrate Buffer Status Reports.

FIGS. 4(a)-4(c) illustrate reports including at least one number of active user stations, transmitted from a relay node to an eNodeB according to various embodiments.

FIG. 5 is a schematic representation of a relay node according to an embodiment.

FIG. 6 is a flow diagram of a method for informing an anchor node of a number of active user stations linked to a relay node according to an embodiment.

FIG. 7 is a flow diagram of a method of allocating radio resources in an anchor node according to an embodiment.

FIG. 8 is a schematic representation of an eNodeB node capable of performing the method illustrated in FIG. 7 according to an embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology associated with radio communication systems that include relays. However, the embodiments to be discussed next are not limited to these systems, but may be applied to other systems that require radio resources allocation when relay nodes are present.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to exemplary embodiments, schedulers in an eNodeB receive information about a number of active user stations linked to each relay node in order to perform resource scheduling among all UEs, independent of whether they are connected to the system directly or via a relay node. For example, the relay nodes may report the number of UEs they actively serve, or a change in the number of UEs they actively serve, or any other coding scheme related to the number of UEs they actively serve.

Whether a user station is active may be determined based on one or more predetermined criteria. According to one exemplary embodiment, relay nodes provide such reports whenever the number of active UEs changes. Furthermore, the report can include information about a plurality of numbers of active UEs, each number corresponding to a different QoS (Quality of Service) class.

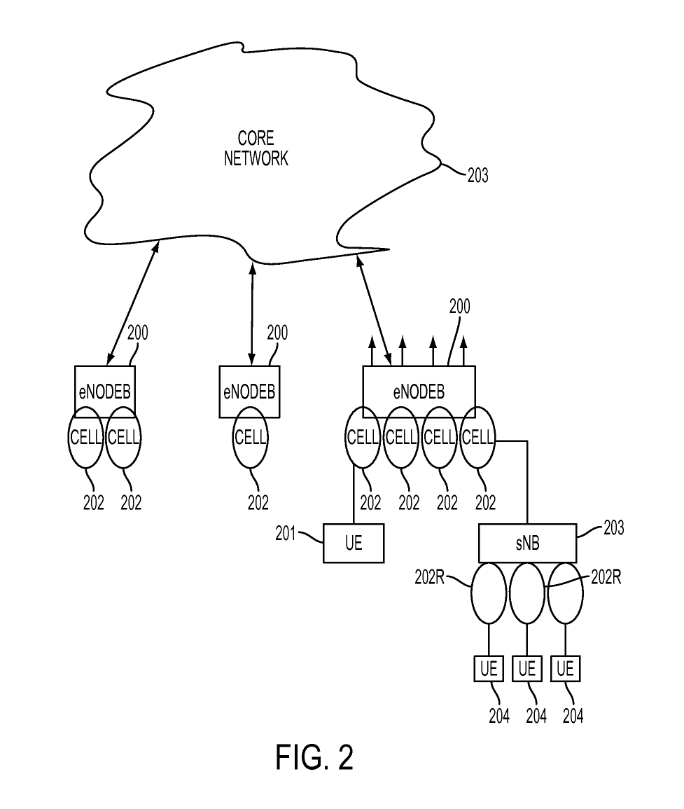

FIG. 2 illustrates an exemplary radio communication system used to describe the following exemplary embodiments. The radio access network nodes and interfaces of the radio communication system in FIG. 2 are described in the context of LTE systems. However, the present invention is not limited in its applicability to LTE systems and can instead be used in any system wherein relays are employed. Since the example in FIG. 2 is described in terms of LTE, the network node, which transmits and receives over the air interface is termed an eNodeB. Several eNodeBs 200 are illustrated in FIG. 2.

In the context of the air interface, each eNodeB 200 is responsible for transmitting signals toward, and receiving signals from, user equipments (UEs) 201 disposed in one or more cells 202. Each eNodeB 200 according to this exemplary embodiment includes multiple antennas (e.g., 2, 4, or more transmit antennas), as well as potentially multiple receive antennas (e.g., 2, 4, or more receive antennas), and handles functions including, but not limited to coding, decoding, modulation, demodulation, interleaving, de-interleaving, etc., with respect to the physical layer of such signals. Note that, as used herein, the phrase “transmit antennas” is specifically meant to include, and be generic to, physical antennas, virtual antennas and antenna ports. The eNodeBs 200 are also responsible for many higher functions associated with handling communications in the system including, for example, scheduling radio resources, handover decisions, and the like.

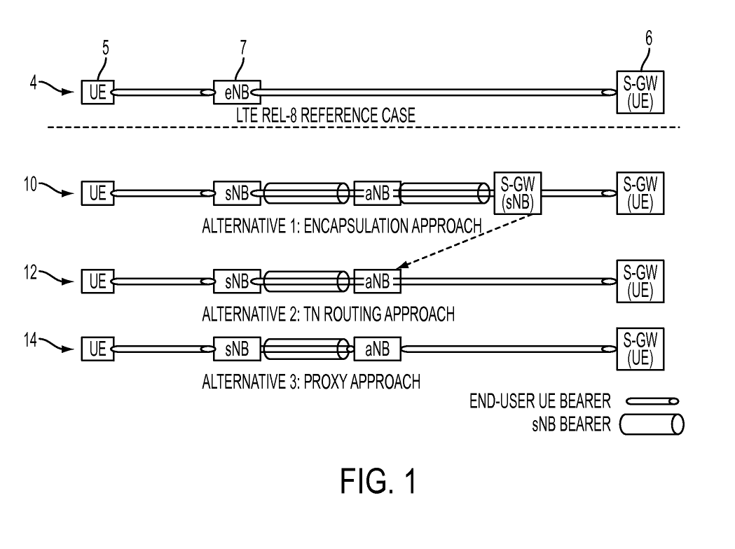

A relay node (sNB) 203 is disposed in a cell 202 of an anchor eNodeB 200. A UE 204, which is operating in a cell 202R as illustrated in FIG. 2 defined by a transmit area associated with the relay node 203, may transmit and/or receive signals via an interface with the relay node 203, e.g., using one of the architectures illustrated in FIG. 1. Similarly, an anchor eNodeB 200 may transmit and/or receive signals via an air interface with the relay node 203.

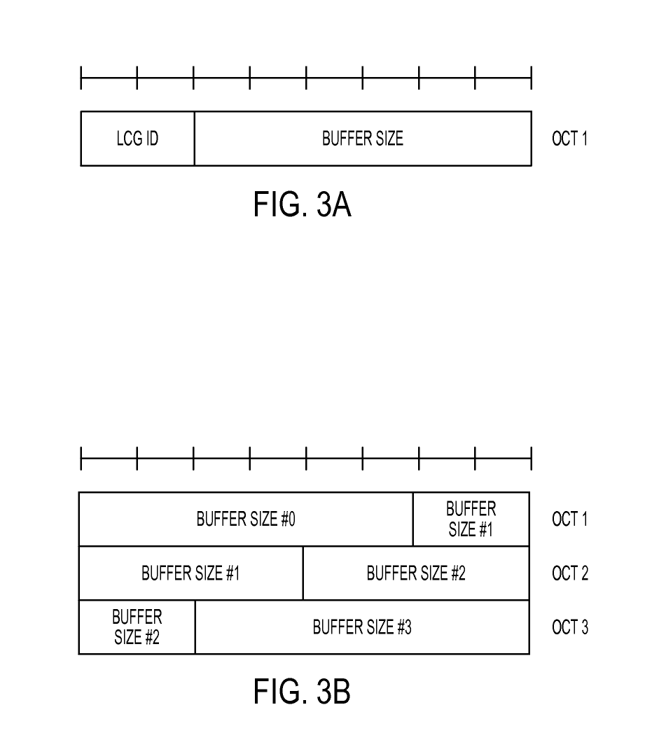

The medium access control (MAC) protocol of LTE Rel-8/9 supports so-called buffer status reports (BSR). Examples of formats for these reports are illustrated in FIGS. 3(a) and 3(b), wherein FIG. 3(a) illustrates a short Buffer Status Report (BSR), and FIG. 3(b) illustrates a long Buffer Status Report (BSR) according to LTE Rel-8/9. These BSRs are designed to provide the uplink scheduler residing in the eNodeB 200 with information about the amount of data queued in the UE(s) 204. The eNodeB 200 uses these BSRs to assign an adequate amount of radio resources to each UE 204 that it is serving, and to choose an appropriate modulation and coding scheme.

Reports having a format similar to the BSRs may be used to provide information about the number of actively connected UEs associated with a given relay node 203 according to various exemplary embodiments. In LTE, a report including information about the number of active user stations associated with a relay node 203, may, for example, be provided as a MAC Control Element (CE). The information about the number of active users may be the absolute value of the number, a variation of the number since the last report or other coding scheme conveying information about the number that is relevant to the scheduling of the resources.

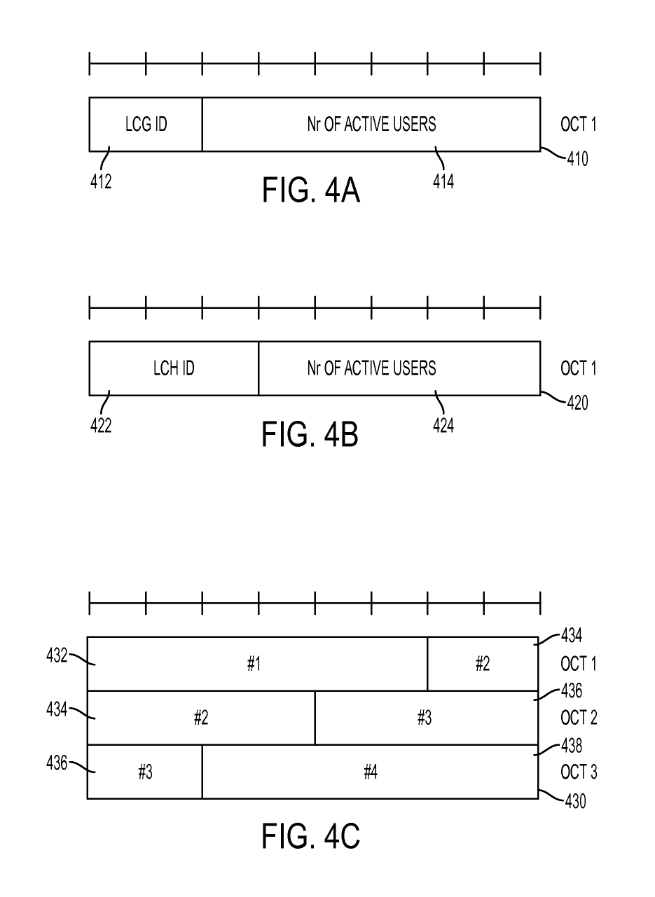

FIGS. 4(a)-4(c) illustrate several exemplary embodiments of formats for the report including information about a number of active user stations, which can be transmitted from a relay node (e.g., 203) to an eNodeB (e.g., 200) via a wireless link. Therein, FIG. 4(a) depicts a report format 410 including a 2-bit logical channel group ID 412 with a 6 bit field 414 representing the information about number of active user stations being reported. FIG. 4(b) depicts a report format 420 including a 3-bit logical channel group ID 422 with a 5 bit field 424 representing the number of active user stations being reported. FIG. 4(c) illustrates a report 430 including 6 bit fields 432, 434, 436, 438 indicating the number of active user stations for different logical channel groups. Those skilled in the art will appreciate that FIGS. 4(a)-4(c) merely show examples of such reports and that other formats are possible.

A relay node 203 may generate and transmit such reports when, for example, the number of UEs 204 that are actively served by the relay node 203 changes. Based on this information, the eNodeB 200 may determine fair data rates for all data flows, including the data flow directed towards the relay node 203. In order to support multiple QoS classes, the relay node 203 may inform the eNodeB 200 not only about an overall number of active user stations served by the relay, but also (or instead) of a plurality of numbers of user stations, each number being associated with a QoS class.

According to an exemplary embodiment, the relay node 203 determines the number of active user stations. For example, the relay node 203 may count each of the UEs having a radio bearer established as an active user station. The drawback of this approach is that at least non-GBR (Guaranteed Bit Rate) bearers are typically maintained even if they are not used. That is, a default radio bearer is established when the UE 204 connects to the network, and the established radio bearer is maintained as long as the RRC (Radio Resource Control) connection is maintained. However, most UEs do not perform continuous data transmission and consequently, a scheduler in the eNodeB should not scale its fairness metric solely based on the number of established radio bearers, although exemplary embodiments do not exclude this possibility. Alternative definitions for the qualifier “active” may be preferred for counting the active user stations, instead of established radio bearers.

For example, according to another embodiment, user stations that have synchronized a timing of a user uplink transmitter of that user station with a timing of the relay node may be counted as active. The UEs with a synchronized uplink in LTE are UEs that ensure that a timing of their uplink transmitter is synchronized with a timing of the eNodeB (or relay). In order to achieve this synchronization, Timing Advance (TA) commands which are issued by the eNodeB (or relay) may be used. The TA commands are generated and submitted if the UE transmits uplink data. Therefore, according to some exemplary embodiments, a time aligned UE may be counted as an active user station.

According to another embodiment, a time since the last communication criterion may be used. For example, user stations for which a time interval since a most recent communication corresponding to that user station is less than a predetermined time interval may be counted as active. A relay node (e.g., 203) may include timers for each UE (e.g., 204) or for each of the UEs' radio bearers. The timer for each UE 204 is started or re-started for each uplink or downlink data unit being received or transmitted by the UE 204, respectively. Alternatively, separate timers could be used for an uplink direction and a downlink direction, respectively, for the same UE 204. A UE 204 may counted as being active while the timer(s) associated with the UE 204 is(are) running, and, may be considered inactive (and not counted) when the timer(s) has (have) expired.

According to another embodiment, user stations 204 for which an average data rate is larger than a threshold data rate value may be counted as active. The relay may monitor an average of the data rate for each UE 204 or preferably for each radio bearer. Furthermore, a threshold data rate may be predefined, and a UE (Radio Bearer) may be counted as active if a current average of the data rate exceeds the predefined threshold.

In addition to the manner in which types of bearers are counted for the report (i.e., what constitutes an “active” user), exemplary embodiments also vary based on when the relay node 203 provides a report to the eNodeB 200. Embodiments using different manners of counting the active user stations (described above) may use any of the methods employed in the embodiments described below to determine when the report is to be submitted.

According to an embodiment, the relay node 203 could provide reports including a current number of active user stations to the eNodeB 200 regularly (i.e., at predetermined moments or equal time intervals). Too infrequent reports may result in inaccuracy, whereas too frequent reports may cause unnecessary control signaling overhead.

According to another embodiment, the relay node 203 could provide reports including a current number of active user stations to the eNodeB 200 when a trigger event occurs. A trigger event may be a change of the number of active user stations 204. Thus, the relay node 203 may generate and/or send a new report whenever the number of active user stations for that relay node changes.

According to another embodiment, in order to reduce a number of the reports triggered by any of the events listed above, a threshold change may be used. For example, the relay node 203 could only be allowed to send a report when more than one user is active. In this context, the relay node 203 may also send a report when the number of active user stations falls below the threshold (i.e., if the number of active user stations drops from being equal or larger than the threshold to being below the threshold).

The timing of submitting a report and other parameters related to the reporting may be controlled and configured by the aNB 200 via control signaling or by an operation and maintenance system. Alternatively, the timing of submitting a report and the other parameters related to the reporting may be fixed, (e.g., in a standard specification of an equipment).

From the foregoing it will be appreciated that exemplary embodiments enable a scheduler in an eNodeB to, among other things, perform resource scheduling in a relaying environment among all UEs no matter whether they are connected directly or via a relay node. A distinguishing feature of some exemplary embodiments is that they support relaying architectures that use encapsulation, i.e., where the eNodeB does not maintain per-UE and per-Radio Bearer contexts for relays (e.g., as illustrated in FIG. 1, first alternative 10).

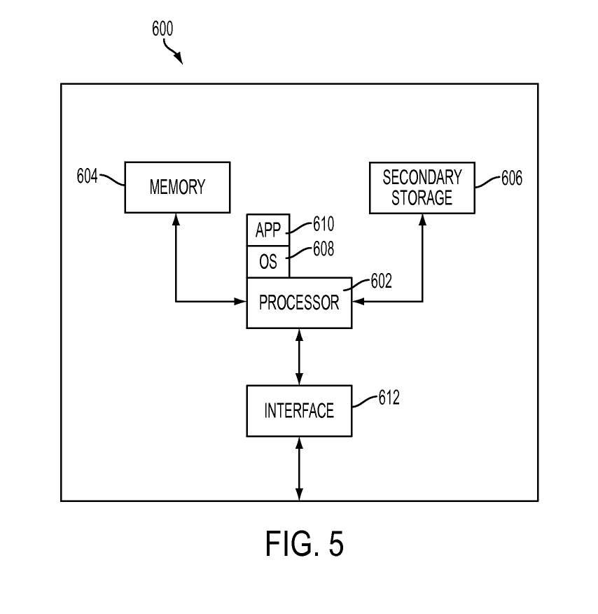

The UE 204, the relay node 203 and the eNodeB 200 can, for example, be implemented using various components, both hardware and software. For example, as shown generally in FIG. 5, an eNodeB 600 can include a processor 602 (or multiple processor cores), a memory 604, one or more secondary storage devices 606 (e.g., external storage device(s)), an operating system 608 running on the processor 602 and using the memory 604, as well as a corresponding application 610, e.g., an application which handles timing alignment in the manner described above. An interface unit 612 may be provided to facilitate communications between the node 600 and the rest of the network or may be integrated into the processor 602. For example, interface unit 612 may include a transceiver capable of communicating wirelessly over an air interface, e.g., as specified by LTE, including hardware and software capable of performing the necessary modulating, coding, filtering and the like, as well as demodulating and decoding to process such signals, including reports associated with the number of active user stations.

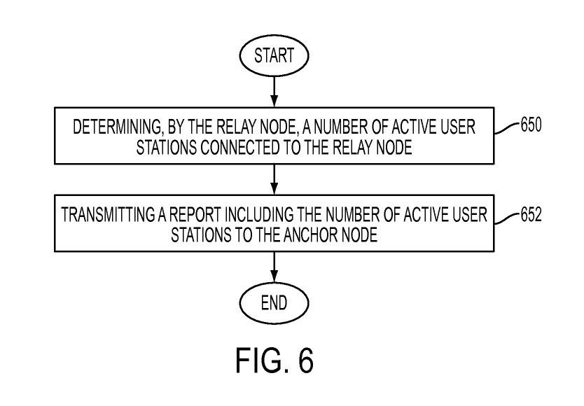

Thus, according to one exemplary embodiment, from the relay node perspective, a method for reporting a number of active user stations may include the steps illustrated in FIG. 6. Therein, at step 650, the relay node determines the number active user stations linked via the relay node. Then, the relay node transmits a report including the number of active user stations at step 652. In other embodiments, the report may include other information on the number of active user stations such as a change in the number since a latest preceding report, or a signal according to a coding scheme related to the number of active user stations.

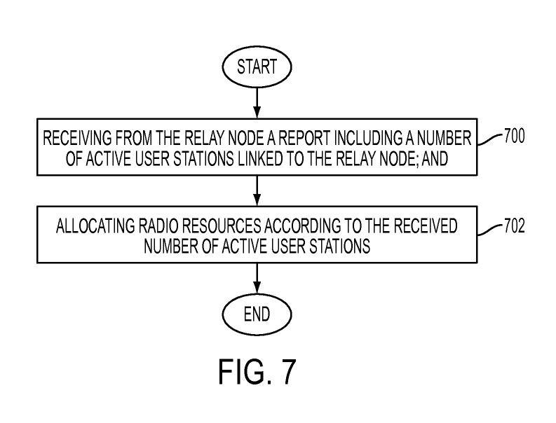

Similarly, according to another exemplary embodiment, from the network or eNodeB perspective, a method for allocating resources may include the steps illustrated in FIG. 7. Therein, at step 700, the eNodeB (or gateway) can receive a report from a relay including a number of active user stations. In other embodiments, the report may include information on the number of active user stations such as a change in the number since a latest preceding report, or a symbol according to a coding scheme related to the number of active user stations. This information can then be used to allocate radio resources at step 702.

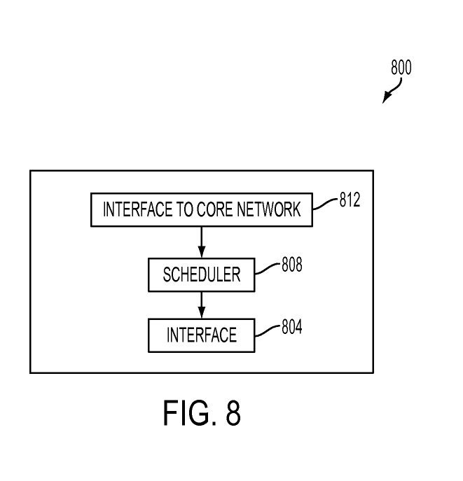

FIG. 8 is a schematic representation of an eNodeB 800 capable to perform the method illustrated in FIG. 7 according to an embodiment. The eNodeB may include an interface communicating to a core network 812, and an interface 804 capable to communicate with a relay node. A scheduler 808 may receive reports including a number of active user from relays via the interface 804.

The disclosed exemplary embodiments provide methods and system that achieve a fair distribution of radio resources based on providing reports related to number of user stations linked via relays. It should be understood that this description is not intended to limit the invention. On the contrary, the exemplary embodiments are intended to cover alternatives, modifications and equivalents, which are included in the spirit and scope of the invention as defined by the appended claims. For example, the afore-described exemplary embodiments could also be used in other radio communication systems than the LTE systems. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for informing an anchor node about a number of active user stations linked to a relay node, which relays data received from the anchor node to the user stations, the method comprising:
determining, by the relay node, a number of active user stations connected to the relay node; and
transmitting a report including information about the number of active user stations to the anchor node.

2. The method of claim 1, wherein the number of active user stations includes at least one of:
those user stations which have a radio bearer established with said relay node; or
those user stations which have a synchronized timing of a user uplink transmitter of that user station with a timing of the relay node.

3. The method of claim 1, further including:
measuring a time interval since a most recent communication between the relay node and a user station, for each of the user stations connected to the relay node,
wherein the number of active user stations includes those user stations for which the time interval corresponding to that user station is less than a predetermined time interval.

4. The method of claim 1, further including:
monitoring an average data rate for each user station connected to the relay node,
wherein the number of active user stations includes those user stations for which the average data rate of that user station is larger than a threshold data rate value.

5. The method of claim 1, further comprising maintaining a predetermined time interval between times of transmission of the report.

6. The method of claim 1, wherein said step of transmitting is performed when at least one of:
a change in the number of active user stations by more than a predetermined value,
the number of active user stations becomes larger than a first predetermined number, or
the number of active user stations becomes smaller than a second predetermined number, occurs.

7. The method of claim 1, wherein:
the step of determining the number of active user stations includes determining at least two numbers of active user stations associated with different quality of service levels, and
the report includes information about the at least two numbers.

8. The method of claim 1, further comprising:
signaling to the anchor node that the report is transmitted using a MAC protocol.

9. The method of claim 8, wherein the report is transmitted to the anchor node as a MAC Control Element.

10. A relay node, comprising:
an interface configured to communicate with an anchor node, and user stations, the relay node being configured to relay data transmitted between the anchor node and any of the user stations; and
a processing unit configured to determine a number of active user stations, and further configured to control the interface to submit a report including information about the number of active user stations to the anchor node.

11. The relay node of claim 10, wherein the number of active user stations includes at least one of:
those user stations which have a radio bearer established with said relay node; or
those user stations which have a synchronized timing of a user uplink transmitter of that user station with a timing of the relay node.

12. The relay node of claim 10, wherein:
the processing unit measures a time interval since a most recent communication between the relay node and a user station, for each of the user stations, and
the number of active user stations includes those user stations for which the time interval corresponding to that user station is less than a predetermined time interval.

13. The relay node of claim 10, wherein:
the processing unit monitors an average data rate for each user station connected to the relay node, and
the processing unit includes in the number of active user stations, those user stations for which the average data rate of that user station is larger than a threshold data rate value.

14. The relay node of claim 10, wherein the processing unit controls the interface to submit the report at predetermined time intervals.

15. The relay node of claim 10, wherein the processing unit controls the interface to submit the report when at least one of:
the number of active user stations changes by more than a predetermined value,
the number of active user stations becomes larger than a first predetermined number, or
the number of active user stations becomes smaller than a second predetermined number occurs.

16. The relay node of claim 10, wherein:
the processing unit determines at least two numbers of active user stations associated with different quality of service levels, and the report includes information about the at least two numbers.

17. An anchor node capable to send data to user stations via a relay node, comprising:
an interface configured to communicate with user stations via a relay node, and to receive a report including information about a number of active stations linked to the relay node; and
a scheduler configured to allocate available radio resources according to the received information about the number of active user stations.

18. The anchor node of claim 17, wherein the report includes at least two numbers of active user stations associated with different quality of service levels, and the scheduler is configured to schedule the available radio resources taking into consideration the information about the at least two numbers and the respective different quality of service levels.

19. The anchor node of claim 17, wherein the number of active user stations includes at least one of:
those user stations for which a radio bearer has been established with said relay
those user stations for which a timing of a user uplink transmitter of that user station is synchronized with a timing of the relay node;
those user stations for which a time interval since the most recent communication with the relay node corresponding to that user station is less than a predetermined time interval; or
those user stations for which an average data rate of that user station with the relay node is larger than a threshold data rate value.

20. A method of allocating radio resources in an anchor node communicating with user stations via a relay node, the method comprising:
receiving from the relay node a report including information about a number of active user stations linked to the relay node; and
allocating radio resources according to the received information about the number of active user stations.

21. The method of claim 20, wherein the report includes information about at least two numbers of active user stations associated with different quality of service levels, and the step of scheduling is performed taking into consideration the information about the at least two numbers and the respective different quality of service levels.

22. The method of claim 20, wherein the number of active user stations includes at least one of:
those user stations for which a radio bearer has been established with said relay node;
those user stations for which a timing of a user uplink transmitter of that user station is synchronized with a timing of the relay node;
those user stations for which a time interval since the most recent communication with the relay node corresponding to that user station is less than a predetermined time interval; or
those user stations for which an average data rate of that user station with the relay node is larger than a threshold data rate value.
